(19) United States
(12) Patent Application Publication
(10) Pub. No.: US 2013/0130846 A1
(43) Pub. Date: May 23, 2013

(54) SPORTING IMPLEMENT FORMED WITH A MELT-PROCESSABLE STRUCTURAL BINDER

(71) Applicant: William B. Giannetti, Winnetka, CA (US)

(72) Inventor: William B. Giannetti, Winnetka, CA (US)

(21) Appl. No.: 13/302,951

(22) Filed: Nov. 22, 2011

(51) Int. Cl. A63B 59/06; A63B 59/14; B62K 3/02; A63B 59/02

(52) U.S. Cl. 473/513; 473/564; 473/561; 264/258; 280/288.3

(57) ABSTRACT

A composite sporting implement, such as a ball bat or bat barrel, is formed with layers of continuous structural fibers embedded in a binder material having a high melting point. Such a binder does not undergo a chemical conversion process during forming of the ball bat. The layers are shaped into a preform and placed in a mold. Heat and pressure are applied to bring the binder to its melting point and to cause the binder material to flow between adjacent layers. The mold is then cooled below the binder's melting point to solidify the composite structure. A composite sporting implement formed in this manner exhibits excellent shear strength, toughness, and damping qualities.

### BACKGROUND

Sporting implements used in baseball, hockey, cycling, lacrosse, and other sports are commonly made from fiber-reinforced composite materials. Composite ball bats, for example, typically include fibers—such as carbon or glass fibers—held together by epoxy or a similar binder material.

Thermoset binders, which are tacky and moldable at room temperature, are commonly used in the construction of composite ball bats and other tubular sporting implements. To create a solid composite impact structure using thermoset binders, a thermal reaction and chemical conversion of the thermoset binder is required. Such a conversion typically occurs at a temperature of approximately 266° F. (130° C.) or below. Once the conversion is completed, the item is returned to room temperature as a solid impact structure.

### BRIEF SUMMARY

A composite sporting implement, such as a ball bat or bat barrel, is formed with layers of continuous structural fibers embedded in a binder material having a high melting point. Such a binder does not undergo a chemical conversion process during forming of the ball bat. The layers are shaped into a preform and placed in a mold. Heat and pressure are applied to bring the binder to its melting point and to cause the binder material to flow between adjacent layers. The mold is then cooled below the binder's melting point to solidify the composite structure. A composite sporting implement formed in this manner exhibits excellent shear strength, toughness, and damping qualities. Other features and advantages will appear hereinafter.

### BRIEF DESCRIPTION OF THE DRAWINGS

FIG. 1 is a side view of a ball bat, according to one embodiment.

FIG. 2 is a sectional view of Section A of FIG. 1, according to one embodiment.

### DETAILED DESCRIPTION OF THE DRAWINGS

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

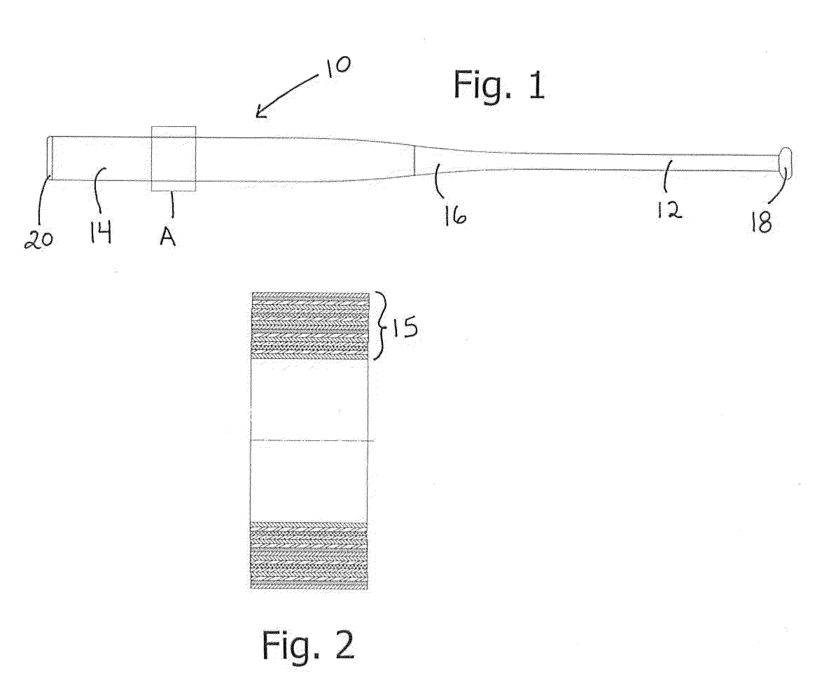

Turning now in detail to the drawings, as shown in FIG. 1, a baseball or softball bat 10, hereinafter collectively referred to as a “ball bat” or “bat,” will be shown and described. It is understood, however, that sporting implements used in other sports, such as hockey, lacrosse, and cycling, may be formed in a similar manner. Thus, a ball bat is shown by way of example only.

The ball bat 10 includes a handle 12, a barrel 14, and a tapered section 16 joining the handle 12 to the barrel 14. The free end of the handle 12 includes a knob 18 or similar structure. The barrel 14 is preferably closed off by a suitable cap 20 or plug. The interior of the bat 10 is preferably hollow, allowing the bat 10 to be relatively lightweight so that ball players may generate substantial bat speed when swinging the bat 10.

The ball bat 10 may be a one-piece construction or may include two or more separate attached pieces (e.g., a separate handle and barrel), as described, for example, in U.S. Pat. No. 5,593,158, which is incorporated herein by reference. The bat handle 12 may be constructed from the same material as, or different materials than, the barrel 14. In a two-piece ball bat, for example, the handle 12 may be constructed from a composite material (the same or a different material than that used to construct the barrel), a metal material, or any other suitable material.

The bat barrel 14 may include a single-wall or multi-wall construction. A multi-wall barrel may include, for example, barrel walls that: are separated from one another by one or more interface shear control zones (“ISCZs”), as described in detail in U.S. Pat. No. 7,115,054, which is incorporated herein by reference. An ISCZ may include, for example, a disbonding layer or other element, mechanism, or space suitable for preventing transfer of shear stresses between neighboring barrel walls. A disbonding layer or other ISCZ preferably further prevents neighboring barrel walls from bonding to each other during molding of, and throughout the life of, the ball bat 10.

The ball bat 10 may have, any suitable dimensions. The ball bat 10 may have an overall length of 20 to 40 inches, or 26 to 34 inches. The overall barrel diameter may be 2.0 to 3.0 inches, or 2.25 to 2.75 inches. Typical ball bats have diameters of 2.25, 2.625, or 2.75 inches. Bats having various combinations of these overall lengths and barrel diameters, or any other suitable dimensions, are contemplated herein. The specific preferred combination of bat dimensions is generally dictated by the user of the bat 10, and may vary greatly between users.

In one embodiment, the bat barrel 14 is constructed from multiple layers 15 of continuous structural fibers of carbon, glass, Kevlar®, or another suitable material embedded in a binder material. The fibers optionally may be oriented unidirectionally within one or more of the layers.

The binder material has an appreciably higher melting point or melting temperature than the melting points of thermoset binder materials used in existing composite ball bats. Further, unlike thermoset binders, the high-melting point binder, or “melt-processable” binder, does not need, to undergo a chemical conversion process during molding of the ball bat 10.

The binder may be made of a nylon polyamide grade material, a polyphenylene sulfide, or a polyether ether ketone having a melting point of approximately 400-450° F. (204-232° C.), 500-550° F. (260-288° C.), or 600-650° F. (316-343° C.), respectively (as determined through dynamic mechanical analysis or another suitable method). Other melt-processable binders may alternatively be used. Binders of this nature exhibit extremely high strain energy properties, and therefore are very effective in high-impact applications, such as striking a pitched baseball.

By contrast, thermoset binders—once they have undergone the necessary chemical conversion process—do not have a workable melting temperature. Indeed, if a thermoset material is heated above its glass-transition temperature (which typically is approximately 212° F. (100° C.)) after being chemically converted to a solid, the strength of the material would be significantly reduced such that the thermoset product would be damaged. Thus, thermoset products cannot be reformed or reshaped by the application of heat while maintaining their required material strength.

In one embodiment of constructing a ball bat or bat barrel, multiple layers of structural fiber embedded in a melt-processable binder are shaped into a bat or barrel preform structure on a mandrel or similar structure. The layers, may be arranged with the fibers oriented at any angles suitable to meet the needs of a given application (for example, to limit the barrel's coefficient of restitution to comply with regulatory association limits). The fibers in a given ply may be oriented unidirectionally, and the angles between fibers in neighboring layers may be the same or different from one another.

Once the preform structure is formed, the mandrel is withdrawn from the preform and is replaced with a heat-resistant, inflatable bladder: The preform is then cut to fit into a bat-shaped or barrel-shaped mold. If excessive moisture is present, the preform may be vacuum-dried before placing it into the mold.

After the preform is placed into the mold, heat is applied until the binder material reaches its melting point. The mold may optionally be pre-heated before placing the preform into the mold. Pressure is applied to promote substantially uniform flowing of the melted binder material between adjacent layers. The mold, which preferably remains under pressure, is then cooled below the binder's melting point so that the binder material hardens and bonds the layers to one another into a solid bat or barrel structure. The bat or barrel is then removed from the mold.

A similar process may be used to construct implements for other sports. For example, composite lacrosse stick shafts, hockey stick shafts, bicycle frame components, and other sporting implements may be formed from structural fibers embedded in a melt-processable binder material. Sporting implements constructed in this manner exhibit excellent shear strength, toughness, and damping qualities. Thus, they are suitable for high-impact, applications, while providing desirable feel characteristics.

Any of the above-described embodiments may be used alone or in combination with one another. Furthermore, the sporting implements may include additional features not described herein. While embodiments have been shown and described, various changes and substitutions may of course be made, without departing from the spirit and scope of the invention. The invention, therefore, should not be limited, except by the following claims and their equivalents.

What is claimed is:

1. A method of making a bat barrel, comprising the steps of:
providing a plurality of layers comprising continuous structural fibers in a binder having a melting point greater than 400° F.;
forming the layers into a barrel preform;
positioning the barrel preform in a mold;
heating the barrel preform in the mold to a temperature sufficient to bring the binder to its melting point so that the binder flows between adjacent layers;
cooling the binder in the mold below its melting point to bond the layers to one another to form a barrel structure; and
removing the barrel structure from the mold.

2. The method of claim 1 further comprising the step of forming the layers into a handle preform that is integral with the barrel preform before positioning the barrel preform in the mold, such that a ball bat including a barrel and an integral handle is formed during the cooling step.

3. The method of claim 1 further comprising the step of pressurizing the mold during the heating and cooling steps.

4. The method of claim 1 wherein the binder does not undergo a chemical conversion process during the heating and cooling steps.

5. A ball bat, comprising:
a handle;
a barrel integral with or attached to the handle, wherein the barrel comprises a plurality of layers of continuous structural fibers bonded to one another by a binder having a melting point greater than 400° F.

6. The ball bat of claim 5 wherein the binder has a melting point between 400 and 450° F.

7. The ball bat of claim 5 wherein the binder has a melting point between 500 and 550° F.

8. The ball bat of claim 5 wherein the binder has a melting point between 600 and 650° F.

9. The ball bat of claim 5 wherein the continuous fibers are unidirectional.

10. A sports implement, comprising:
a tubular body comprising a plurality of layers of continuous, unidirectional fibers bonded to one another by a binder having a melting point greater than 400° F.

11. The sports implement of claim 10 wherein the tubular body is in the form of a lacrosse stick shaft.

12. The sports implement of claim 10 wherein the tubular body is in the form of a hockey stick shaft.

13. The sports implement of claim 10 wherein the tubular body is in the form of a bicycle frame component.

14. The ball bat of claim 10 wherein the binder has a melting point between 400 and 450° F.

15. The ball bat of claim 10 wherein the binder has a melting point between 500 and 550° F.

16. The ball bat of claim 10 wherein the binder has a melting point between 600 and 650° F.

17. The ball bat of claim 10 wherein the continuous fibers are unidirectional.

18. A method of making a sporting implement, comprising the steps of:
providing a plurality of layers comprising continuous structural fibers in a binder having a melting point greater than 400° F.;
forming the layers into a preform;
positioning the preform in a mold;
heating the preform in the mold to a temperature sufficient to bring the binder to its melting point so that the binder flows between adjacent layers;
cooling the binder in the mold below its melting point to bond the layers to one another to form a sporting implement; and
removing the sporting implement from the mold.

19. The method of claim 18 further comprising the step of pressurizing the mold during the heating and cooling steps.

20. The method of claim 18 wherein the binder does not undergo a chemical conversion process during the heating and cooling steps.
